(19) United States
(12) Patent Application Publication
(10) Pub. No.: US 2024/0030805 A1
(43) Pub. Date: Jan. 25, 2024

(54) PROTECTION CIRCUIT, DC-DC CONVERTER, BATTERY CHARGER AND ELECTRIC VEHICLE

(71) Applicant: LG ENERGY SOLUTION, LTD., Seoul (KR)

(72) Inventor: Seok-Hyeong HAM, Daejeon (KR)

(73) Assignee: LG ENERGY SOLUTION, LTD., Seoul (KR)

(21) Appl. No.: 18/024,078

(22) PCT Filed: Aug. 25, 2021
(86) PCT No.: PCT/KR2021/011403

§ 371 Date: Mar. 1, 2023

(30) Foreign Application Priority Data
Sep. 2, 2020 (KR) 10-2020-0111845

(51) Int. Cl. H02M 1/34; H02J 7/00; H02M 3/158; H02M 1/00; B60L 53/22

(52) U.S. Cl. CPC H02M 1/346; H02J 7/007; H02M 3/158; H02M 1/0054; B60L 53/22; H02J 2207/20; B60L 2210/12

(57) ABSTRACT

Discussed is a protection circuit for a direct current-direct current (DC-DC) converter, the protection circuit including a buck switch connected between a voltage input terminal and a first node, the buck switch being controlled by a switching cycle and a duty cycle of a switching signal, a buck inductor connected between the first node and a voltage output terminal, a buck capacitor connected between the voltage output terminal and a ground, and a buck diode connected between a second node and the ground. The protection circuit is connected to the first node, the second node and the ground. When the buck switch is switched between an On state and an OFF state according to the switching signal, the protection circuit is configured to supply a protection voltage between the first node and the ground so that voltage stress of the buck switch is smaller than an input voltage supplied between the voltage input terminal and the ground.

### TECHNICAL FIELD

The present disclosure relates to technology for protecting a direct current (DC)-DC converter from switching loss.

The present application claims priority to Korean Patent Application No. 10-2020-0111845 filed on Sep. 2, 2020 in the Republic of Korea, the disclosure of which is incorporated herein by reference.

### BACKGROUND ART

Recently, there has been a rapid increase in the demand for portable electronic products such as laptop computers, video cameras and mobile phones, and with the extensive development of electric vehicles, accumulators for energy storage, robots and satellites, many studies are being made on high performance batteries that can be recharged repeatedly.

Currently, commercially available batteries include nickel-cadmium batteries, nickel-hydrogen batteries, nickel-zinc batteries, lithium batteries and the like, and among them, lithium batteries have little or no memory effect, and thus they are gaining more attention than nickel-based batteries for their advantages that recharging can be done whenever it is convenient, the self-discharge rate is very low and the energy density is high.

An electric vehicle includes a battery and a battery charger. The battery charger generates the charge power for the battery using the input power from an external power source when connected to the external power source through a charging cable. In general, the battery charger includes a direct current (DC)-DC converter to generate the output voltage that is lower than the input voltage.

To keep up with the recent trend toward lightweight electric vehicles, there is a growing demand for lighter and smaller DC-DC converters. To reduce the weight and size of the DC-DC converter, it is necessary to increase the switching frequency of a switching signal rather than reducing the size of each physical device included in the DC-DC converter. FIG. 1 is a schematic diagram of a common DC-DC stepdown converter.

Referring to FIG. 1, the DC-DC converter includes a buck switch SW_{B} connected between a voltage input terminal Nᵢ and a first node N₁; a buck inductor L_{B} connected between the first node N₁ and a voltage output terminal Nₒ; a buck capacitor C_{B} connected between the voltage output terminal Nₒ and the ground; and a buck diode D_{B} connected between the first node N₁ and the ground. When the buck switch SW_{B} is switched from an ON state to an OFF state, the buck diode D_{B} is turned on, and voltage which is, in substance, equal to 0V, is supplied between the first node N₁ and the ground. On the contrary, when the buck switch SW_{B} is switched from the OFF state to the ON state, the buck diode D_{B} is turned off, and voltage which is, in substance, equal to the input voltage Vin is supplied between the first node N₁ and the ground. As a result, each time the buck switch SW_{B} is switched between the ON state and the OFF state, voltage stress which is, in substance, equal to the input voltage Vᵢₙ, occurs across the buck switch SW_{B}.

However, since the switching loss of the DC-DC converter is proportional to the voltage stress, when the switching frequency increases, the power efficiency of the DC-DC converter reduces, and the DC-DC converter is overheated.

### DISCLOSURE

### Technical Problem

The present disclosure is designed to solve the above-described problem, and therefore the present disclosure is directed to providing a protection circuit for protecting a direct current (DC)-DC converter from switching loss, a battery charger comprising the protection circuit and an electric vehicle comprising the battery charger.

These and other objects and advantages of the present disclosure may be understood by the following description and will be apparent from the embodiments of the present disclosure. In addition, it will be readily understood that the objects and advantages of the present disclosure may be realized by the means set forth in the appended claims and a combination thereof.

### Technical Solution

A protection circuit according to an aspect of the present disclosure is provided for a direct current (DC)-DC converter. The DC-DC converter includes a buck switch connected between a voltage input terminal and a first node, the buck switch being controlled by a switching cycle and a duty cycle of a switching signal; a buck inductor connected between the first node and a voltage output terminal; a buck diode connected between a second node and a ground; and a buck capacitor connected between the voltage output terminal and the ground. The protection circuit is connected to the first node, the second node and the ground. When the buck switch is switched between an On state and an OFF state according to the switching signal, the protection circuit is configured to supply a protection voltage between the first node and the ground so that voltage stress of the buck switch is smaller than an input voltage supplied between the voltage input terminal and the ground.

The protection circuit includes a first protection capacitor connected between the first node and the second node; a second protection capacitor connected between a third node and the ground; a protection inductor connected between the second node and the third node; and a protection diode connected between the first node and the third node.

The protection diode is kept in the OFF state in a first period of time during which the buck switch is in the ON state. The protection diode is kept in the ON state in a second period of time during which the buck switch is in the OFF state.

The protection voltage may be equal to a voltage of a series circuit of the first protection capacitor and the buck diode.

A voltage of a series circuit of the first protection capacitor, the protection inductor and the second protection capacitor may be equal to a sum of a voltage of the buck inductor and an output voltage in a first period of time during which the buck switch is in the ON state. The output voltage is a voltage between the voltage output terminal and the ground.

A voltage of the first protection capacitor may be equal to a voltage of a series circuit of the protection inductor and the protection diode in the second period of time during which the buck switch is in the OFF state.

A voltage of the second protection capacitor may be equal to a voltage of a series circuit of the protection inductor and the buck diode in the second period of time during which the buck switch is in the OFF state.

A DC-DC converter according to another aspect of the present disclosure includes the protection circuit.

A battery charger according to still another aspect of the present disclosure includes the DC-DC converter.

An electric vehicle according to yet another aspect of the present disclosure includes the battery charger and a battery connected between the voltage output terminal and the ground.

### Advantageous Effects

According to at least one of the embodiments of the present disclosure, it is possible to reduce the switching loss of the buck switch included in the direct current (DC)-DC converter without using an additional switch requiring on-off control.

Additionally, as the switching frequency increases in response to the decreasing switching loss of the buck switch, it is possible to achieve the lightweight and compact design of the DC-DC converter.

The effects of the present disclosure are not limited to the effects mentioned above, and these and other effects will be clearly understood by those skilled in the art from the appended claims.

### DESCRIPTION OF DRAWINGS

The accompanying drawings illustrate a preferred embodiment of the present disclosure, and together with the detailed description of the present disclosure described below, serve to provide a further understanding of the technical aspects of the present disclosure, and thus the present disclosure should not be construed as being limited to the drawings.

FIG. 1 is a schematic diagram of a common direct current (DC)-DC stepdown converter.

FIG. 2 is an exemplary diagram showing a configuration of an electric vehicle of the present disclosure.

FIG. 3 is an exemplary diagram showing a configuration of a battery charger according to the present disclosure.

FIG. 4 is an exemplary diagram showing a configuration of a DC-DC converter of FIG. 3.

FIG. 5 is a schematic diagram showing a current waveform of each device and a voltage waveform of a buck switch over a single switching cycle during the operation of the DC-DC converter of FIG. 4 in a steady state.

### BEST MODE

Hereinafter, the preferred embodiments of the present disclosure will be described in detail with reference to the accompanying drawings. Prior to the description, it should be understood that the terms or words used in the specification and the appended claims should not be construed as being limited to general and dictionary meanings, but rather interpreted based on the meanings and concepts corresponding to the technical aspects of the present disclosure on the basis of the principle that the inventor is allowed to define the terms appropriately for the best explanation.

Therefore, the embodiments described herein and illustrations shown in the drawings are just a most preferred embodiment of the present disclosure, but not intended to fully describe the technical aspects of the present disclosure, so it should be understood that a variety of other equivalents and modifications could have been made thereto at the time that the application was filed.

The terms including the ordinal number such as “first”, “second” and the like, are used to distinguish one element from another among various elements, but not intended to limit the elements by the terms.

Unless the context clearly indicates otherwise, it will be understood that the term “comprises” when used in this specification, specifies the presence of stated elements, but does not preclude the presence or addition of one or more other elements. Additionally, the term “control unit” refers to a processing unit of at least one function or operation, and this may be implemented by hardware and software either alone or in combination.

In addition, throughout the specification, it will be further understood that when an element is referred to as being “connected to” another element, it can be directly connected to the other element or intervening elements may be present.

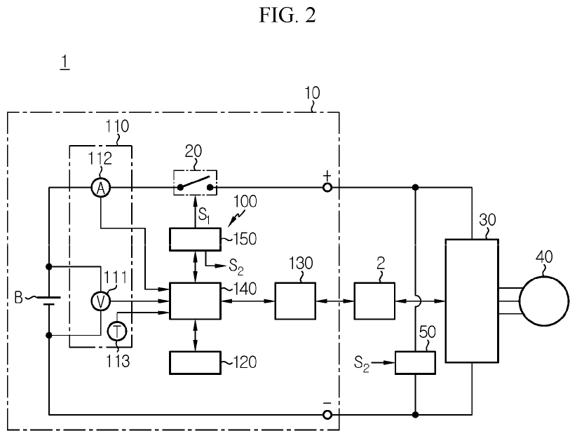

FIG. 2 is an exemplary diagram showing a configuration of an electric vehicle of the present disclosure.

Referring to FIG. 2, the electric vehicle 1 includes a battery pack 10, an inverter 30, an electric motor 40 and a battery charger 50.

The battery pack 10 includes a battery B, a relay 20 and a battery management system 100.

The battery B includes at least one battery cell. Each battery cell is not limited to a particular type, and may include any battery cell that can be repeatedly recharged such as, for example, a lithium ion cell. The battery B may be coupled to the inverter 30 through a pair of power terminals provided in the battery pack 10.

The relay 20 is connected in series to the battery B. The relay 20 is installed on a current path for the charge/discharge of the battery B. The on-off control of the relay 20 is performed in response to a control signal from the battery management system 100. The relay 20 may be a mechanical relay that is turned on/off by the electromagnetic force of a coil or a semiconductor switch such as a Metal Oxide Semiconductor Field Effect transistor (MOSFET).

The inverter 30 is provided to convert the DC power from the battery B to alternating current (AC) power in response to a command from the battery management system 100. The electric motor 40 may be, for example, a 3-phase AC motor. The electric motor 40 works using the AC power from the inverter 30.

The battery management system 100 is provided to perform the general control related to the charge/discharge of the battery B.

The battery management system 100 includes a sensing unit 110, a memory unit 120 and a control unit 140. The battery management system 100 may further include at least one of an interface unit 130 or a switch driver 150.

The sensing unit 110 includes a voltage sensor 111 and a current sensor 112. The sensing unit 110 may further include a temperature sensor 113.

The voltage sensor 111 is connected in parallel to the battery B, and is configured to detect a battery voltage across the battery B and generate a voltage signal indicating the detected battery voltage. The current sensor 112 is connected in series to the battery B through the current path. The current sensor 112 is configured to detect a battery current flowing through the battery B and generate a current signal indicating the detected battery current. The temperature sensor 113 is configured to detect a temperature of the battery B and generate a temperature signal indicating the detected temperature.

The memory unit 120 may include at least one type of storage medium of flash memory type, hard disk type, Solid State Disk (SSD) type, Silicon Disk Drive (SDD) type, multimedia card micro type, random access memory (RAM), static random access memory (SRAM), read-only memory (ROM), electrically erasable programmable read-only memory (EEPROM) or programmable read-only memory (PROM). The memory unit 120 may store data and programs required for the computation operation by the control unit 140. The memory unit 120 may store data indicating the result of the computation operation by the control unit 140.

The interface unit 130 may include a communication circuit configured to support wired or wireless communication between the control unit 140 and a high-level controller 2 (for example, an Electronic Control Unit (ECU)). The wired communication may be, for example, controller area network (CAN) communication, and the wireless communication may be, for example, Zigbee or Bluetooth communication. The communication protocol is not limited to a particular type, and may include any communication protocol that supports the wired/wireless communication between the control unit 140 and the high-level controller 2. The interface unit 130 may include an output device (for example, a display, a speaker) to provide information received from the control unit 140 and/or the high-level controller 2 in a recognizable format. The high-level controller 2 may control the inverter 30 based on battery information (for example, voltage, current, temperature, SOC) collected through the communication with the battery management system 100.

The control unit 140 may be operably coupled to the high-level controller 2, the relay 20, the sensing unit 110, the memory unit 120, the interface unit 130 and/or the switch driver 150. The control unit 140 may be implemented in hardware using at least one of application specific integrated circuits (ASICs), digital signal processors (DSPs), digital signal processing devices (DSPDs), programmable logic devices (PLDs), field programmable gate arrays (FPGAs), microprocessors, or electrical units for performing the other functions.

The switch driver 150 is configured to output a switching signal S₁ to the relay 20 in response to a command from the control unit 140. The switch driver 150 is configured to output a switching signal S₂ to the battery charger 50 in response to the command from the control unit 140.

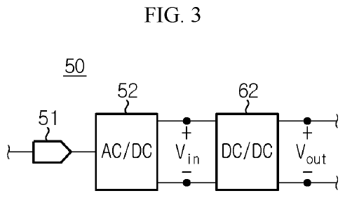

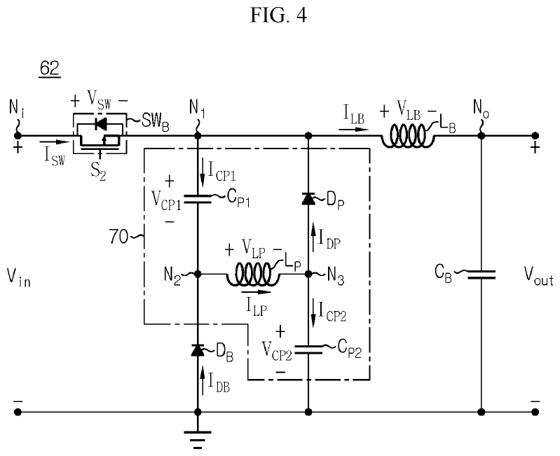

FIG. 3 is an exemplary diagram showing the configuration of the battery charger according to the present disclosure, and FIG. 4 is an exemplary diagram showing the configuration of the DC-DC converter of FIG. 3.

Referring to FIGS. 3 and 4, the battery charger 50 is provided to be connectable to two terminals of the battery B. The battery charger 50 includes the DC-DC converter 62. The battery charger 50 may further include a charger plug 51 and an AC-DC converter 52.

The AC-DC converter 52 is configured to convert the AC power from an AC charging state (not shown) connected to the charger plug 51 to DC power having a predetermined voltage level.

The DC-DC converter 62 is configured to generate the charge power for the battery B using the DC power from the AC-DC converter 52 or a DC charging station (not shown).

The DC-DC converter 62 is a buck converter which steps down the input voltage Vᵢₙ to generate the output voltage Vₒᵤₜ lower than the input voltage Vᵢₙ. The DC-DC converter 62 includes a voltage input terminal Nᵢ, a voltage output terminal No, a buck switch SW_{B}, a buck inductor L_{B}, a buck capacitor C_{B}, a buck diode D_{B} and a protection circuit 70. The protection circuit 70 may be referred to as a ‘passive snubber’.

The input voltage Vᵢₙ from the AC-DC converter 52 or the DC charging station may be supplied between the voltage input terminal Nᵢ and the ground. The battery B may be connected between the voltage output terminal Nₒ and the ground.

The buck switch SW_{B} is connected between the voltage input terminal Nᵢ and the first node N₁. The on-off control of the buck switch SW_{B} is performed in response to the switching signal S₂ from the switch driver 150. The buck switch SW_{B} may be a well-known switching device, for example, MOSFET. When the switching cycle and the duty cycle of the switching signal S₂ are Tₛ and D, respectively, the buck switch SW_{B} is kept in the ON state for a first period of time of T_{S}×D, and is kept in the OFF state for a second period of time of T_{S}×(1-D). The sum of the first period of time and the second period of time is equal to the switching cycle T_{S}.

The buck inductor L_{B} is connected between the first node N₁ and the voltage output terminal No. The buck inductor L_{B} is charged by the input current from the first node N₁ for the first period of time. The energy charged in the buck inductor L_{B} for the first period of time is supplied to the voltage output terminal Nₒ for the second period of time. The equilibrium between the energy charged in the buck inductor L_{B} for the first period of time and the energy discharged from the buck inductor L_{B} for the second period of time may be referred to ‘steady state’ of the DC-DC converter 62.

The buck capacitor C_{B} is connected between the voltage output terminal Nₒ and the ground. The buck capacitor C_{B} is provided to suppress the ripple of the output voltage Vₒᵤₜ supplied between the voltage output terminal Nₒ and the ground.

The buck diode D_{B} is connected between a second node N₂ and the ground. Specifically, the anode and the cathode of the buck diode D_{B} are connected to the ground and the second node N₂, respectively. For the first period of time during which the buck switch SW_{B} is in the ON state, the potential of the second node N₂ is higher than the ground potential, and the buck diode D_{B} gets into the OFF state. For the second period of time during which the buck switch SW_{B} is in the OFF state, the potential of the second node N₂ is lower than the ground potential, and the buck diode D_{B} gets into the OFF state. While the buck diode D_{B} is in the ON state, the electric current from the ground to the second node N₂ flows through the buck diode D_{B}.

The protection circuit 70 is connected to the first node N₁, the second node N₂ and the ground. The protection circuit 70 is configured to supply a protection voltage between the first node N₁ and the ground when the buck switch SW_{B} is switched from any one of the ON state and the OFF state to the other by the switching signal S₂. Since the voltage stress of the buck switch SW_{B} is a voltage difference between the voltage input terminal Nᵢ and the first node N₁, the voltage stress of the buck switch SW_{B} is reduced below the input voltage Vᵢₙ supplied between the voltage input terminal Nᵢ and the ground by the protection voltage.

The protection circuit 70 includes a first protection capacitor C_{P1}, a second protection capacitor C_{P2}, a protection inductor L_{P} and a protection diode D_{P}.

In FIG. 4, I_{SW} denotes the electric current flowing through the buck switch SW_{B}, I_{LB} denotes the electric current flowing through the buck inductor L_{B}, I_{LP} denotes the electric current flowing through the protection inductor L_{P}, I_{CP1} denotes the electric current flowing through the first protection capacitor C_{P1}, I_{CP2} denotes the electric current flowing through the second protection capacitor C_{P2}, I_{DB} denotes the electric current flowing through the buck diode D_{B}, I_{DP} denotes the electric current flowing through the protection diode D_{P}, and V_{SW} denotes the voltage stress of the buck switch SW_{B}.

The first protection capacitor C_{P1} is connected between the first node N₁ and the second node N₂.

The second protection capacitor C_{P2} is connected between a third node N₃ and the ground.

The first protection capacitor C_{P1} and the second protection capacitor C_{P2} reduce the magnitude of the voltage stress SW_{B} of the buck switch SW_{B} by supplying the protection voltage between the first node N₁ and the ground when the buck switch SW_{B} is switched between the ON state and the OFF state.

The protection inductor L_{P} is connected between the second node N₂ and the third node N₃. The protection inductor L_{P} is provided to suppress a sharp change in the electric current I_{CP1} of the first protection capacitor C_{P1} and the electric current I_{CP2} of the second protection capacitor C_{P2} during the charge and discharge of the first protection capacitor C_{P1} and the second protection capacitor C_{P2}.

The protection diode D_{P} is connected between the first node N₁ and the third node N₃. Specifically, the anode and the cathode of the protection diode D_{P} are connected to the third node N₃ and the first node N₁, respectively. When the potential of the first node N₁ is lower than the potential of the third node N₃, the protection diode D_{P} gets into the ON state. While the protection diode D_{P} is in the ON state, the electric current I_{DP} from the third node N₃ to the first node N₁ flows through the protection diode D_{P}. When the potential of the first node N₁ is higher than the potential of the third node N₃, the protection diode D_{P} gets into the OFF state. While the protection diode D_{P} is in the OFF state, the flow of the electric current between the first node N₁ and the third node N₃ is interrupted.

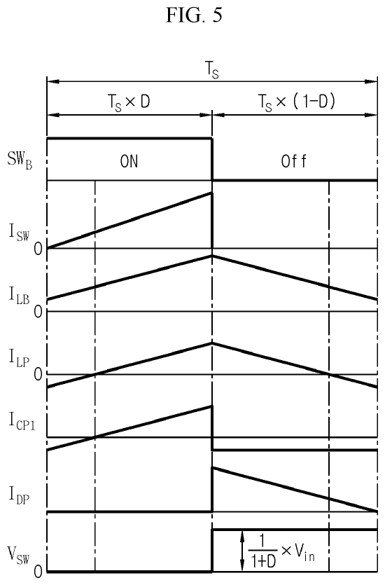

FIG. 5 is a schematic diagram showing a current waveform of each device and a voltage waveform of the buck switch over a single switching cycle during the operation of the DC-DC converter 62 of FIG. 4 in a steady state.

Referring to FIG. 5, a single switch cycle may be divided into four continuous operation modes according to the state of the buck switch SW_{B} and the direction of the electric current of the protection inductor L_{P}. In the first to fourth operation modes, the electric current I_{CP1} is equal to the electric current I_{CP2}, and the electric current I_{DP} is equal to the electric current I_{DB}, and thus the waveform of the electric current I_{CP2} and the waveform of the electric current I_{DB} are omitted from FIG. 5.

The first operation mode is an operation mode from the time at which the buck switch SW_{B} is switched from the OFF state to the ON state to the time at which the electric current I_{LP} reaches 0 A from a negative value. The electric current I_{LP} having the negative value in the first operation mode represents that the first protection capacitor C_{P1}) and the second protection capacitor C_{P2} are discharged in the first operation mode.

The second operation mode is an operation mode in which the electric current I_{LP} gradually rises from 0A while the buck switch SW_{B} is kept in the ON state. The electric current I_{LP} having a positive value that is larger than 0 A in the second operation mode represents that the first protection capacitor C_{P1} and the second protection capacitor C_{P2} are charged in the second operation mode.

In the first operation mode and the second operation mode, the buck diode D_{B} and the protection diode D_{P} are in the OFF state. Accordingly, a voltage of a series circuit of the first protection capacitor C_{P1}, the protection inductor L_{P} and the second protection capacitor C_{P2} is equal to the input voltage Vᵢₙ.

The third operation mode is an operation mode from the time at which the buck switch SW_{B} is switched from the ON state to the OFF state to the time at which the electric current I_{LP} reaches 0 A from a positive value.

The fourth operation mode is an operation mode in which the electric current I_{LP} gradually reduces from 0A while the buck switch SW_{B} is kept in the OFF state.

In the third operation mode and the fourth operation mode, the buck diode D_{B} and the protection diode D_{P} are in the ON state, and thus a series circuit of the first protection capacitor C_{P1} and the buck diode D_{B} supplies the protection voltage that is larger than 0V between the first node N₁ and the ground. That is, the protection voltage may be equal to a voltage across the series circuit of the first protection capacitor CH and the buck diode D_{B}.

When the buck switch SW_{B} is in the ON state, the voltage of the first node N₁ is equal to the input voltage Vᵢₙ, and the voltage V_{LB} of the buck inductor L_{B} is equal to a voltage difference between the input voltage Vᵢₙ and the output voltage Vₒᵤₜ. Accordingly, in the first operation mode and the second operation mode, a relationship of the following Equations 1 and 2 is satisfied.

V_{LP}=Vᵢₙ−V_{CP1}−V_{CP2}=Vᵢₙ−2V_{CP1} <Equation 1>

V_{LB}=Vᵢₙ−Vₒᵤₜ <Equation 2>

When the buck switch SW_{B} is in the OFF state, the buck diode D_{B} and the protection diode D_{P} are in the ON state, and thus equalization may be implemented by the parallel connection of the first protection capacitor C_{P1}, the protection inductor L_{P} and the second protection capacitor C_{P2} between the first node N₁ and the ground. Accordingly, when it is assumed that forward voltage drop of each of the buck diode D_{B} and the protection diode D_{P} is 0 V, in the third operation mode and the fourth operation mode, a relationship of the following Equations 3 and 4 is satisfied.

V_{LP}=−V_{CP1}−V_{CP2} <Equation 3>

V_{LB}=V_{CP1}−Vₒᵤₜ=V_{CP2}−Vₒᵤₜ=−V_{LP}−Vₒᵤₜ <Equation 4>

During the operation of the DC-DC converter 62 in a steady state, an average voltage of each of the buck inductor L_{B}) and the protection inductor L_{P} over a single switching cycle is 0 V according to the voltage-volt-second balance rule. Accordingly, the following Equation 5 is derived from Equations 1 and 3, and the following Equation 6 is derived from Equations 2 and 4.

(Vᵢₙ−2V_{CP1})×D−V_{CP1}×(1-D)=0[V] <Equation 5>

(Vᵢₙ−Vₒᵤₜ)×D+(V_{CP1}−Vₒᵤₜ)×(1-D)=0[V] <Equation 6>

When Equation 5 is rewritten with respect to V_{CP1}, the following Equation 5-1 is given.

$${V}_{CP 1} = \frac{D}{1 + D} \times {V}_{in} \qquad < Equation 5 - 1 >$$

When Equation 6 is rewritten with respect to Vₒᵤₜ using Equation 5-1, the following Equation 6-1 is given.

$${V}_{out} = \frac{2 D}{1 + D} \times {V}_{i n} = {G}_{V} \times {V}_{i n} \qquad < Equation 6 - 1 >$$

In Equation 6-1, Gv is a voltage gain of the DC-DC converter 62.

Additionally, the voltage stress when the buck switch SW_{B} is switched from the ON state to the OFF state is shown in the following Equation 7.

$${V}_{SW} = {V}_{i n} - {V}_{CP 1} = \frac{D}{1 + D} \times {V}_{in} \qquad < Equation 7 >$$

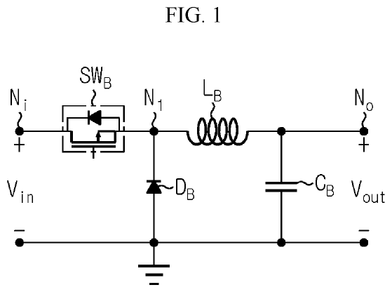

The duty cycle D is between 0-1. Accordingly, the voltage stress V_{SW} of the DC-DC converter 62 reduces by 1/(1+D) of the input voltage Vᵢₙ by the protection circuit 70. That is, in the conventional DC-DC converter shown in FIG. 1, voltage stress having the same magnitude as the input voltage Vᵢₙ is supplied to the buck switch SW_{B} irrespective of the duty cycle D, while in the DC-DC converter 62 according to the present disclosure, the voltage stress V_{SW} that is smaller than the input voltage Vᵢₙ is supplied to the buck switch SW_{B}. Additionally, the DC-DC converter 62 according to the present disclosure reduces in voltage stress V_{SW} of the buck switch SW_{B} with the increasing duty cycle D. The control unit 140 may increase the duty cycle D by a predetermined ratio at a preset time interval using the DC-DC converter 62 during the charge of the battery B.

While the present disclosure has been hereinabove described with regard to a limited number of embodiments and drawings, the present disclosure is not limited thereto and it is obvious to those skilled in the art that various modifications and changes may be made thereto within the technical aspects of the present disclosure, the appended claims and their equivalent scope.

Additionally, as many substitutions, modifications and changes may be made to the present disclosure by those skilled in the art without departing from the technical aspects of the present disclosure, the present disclosure is not limited by the above-described embodiments and the accompanying drawings, and some or all of the embodiments may be selectively combined to allow various modifications.

1. A protection circuit for a direct current-direct current (DC-DC) converter, the protection circuit comprising:
a buck switch connected between a voltage input terminal and a first node, the buck switch being controlled by a switching cycle and a duty cycle of a switching signal;
a buck inductor connected between the first node and a voltage output terminal;
a buck diode connected between a second node and a ground; and
a buck capacitor connected between the voltage output terminal and the ground,
wherein the protection circuit is connected to the first node, the second node and the ground, and
wherein, when the buck switch is switched between an On state and an OFF state according to the switching signal, the protection circuit is configured to supply a protection voltage between the first node and the ground so that voltage stress of the buck switch is smaller than an input voltage supplied between the voltage input terminal and the ground.

2. The protection circuit according to claim 1, wherein the protection circuit includes:
a first protection capacitor connected between the first node and the second node;
a second protection capacitor connected between a third node and the ground;
a protection inductor connected between the second node and the third node; and
a protection diode connected between the first node and the third node.

3. The protection circuit according to claim 2, wherein the protection diode is kept in the OFF state in a first period of time during which the buck switch is in the ON state, and is kept in the ON state in a second period of time during which the buck switch is in the OFF state.

4. The protection circuit according to claim 2, wherein the protection voltage is equal to a voltage of a series circuit of the first protection capacitor and the buck diode.

5. The protection circuit according to claim 2, wherein a voltage of a series circuit of the first protection capacitor, the protection inductor and the second protection capacitor is equal to a sum of a voltage of the buck inductor and an output voltage in a first period of time during which the buck switch is in the ON state, and
wherein the output voltage is a voltage between the voltage output terminal and the ground.

6. The protection circuit according to claim 2, wherein a voltage of the first protection capacitor is equal to a voltage of a series circuit of the protection inductor and the protection diode in the second period of time during which the buck switch is in the OFF state.

7. The protection circuit according to claim 2, wherein a voltage of the second protection capacitor is equal to a voltage of a series circuit of the protection inductor and the buck diode in the second period of time during which the buck switch is in the OFF state.

8. A DC-DC converter comprising the protection circuit according to claim 1.

9. A battery charger comprising the DC-DC converter according to claim 8.

10. An electric vehicle comprising the battery charger according to claim 9.
